(19) United States
(12) Patent Application Publication
(10) Pub. No.: US 2016/0280293 A1
(43) Pub. Date: Sep. 29, 2016

(54) Break-In Coating on Track Assembly Components

(71) Applicant: Caterpillar Inc., Peoria, IL (US)

(72) Inventors: Bao Feng, Dunlap, IL (US); Mark Diekevers, Germantown Hills, IL (US); William Baar, Peoria, IL (US); Douglas Weaver, Peoria Heights, IL (US); Hyung Yoon, Peoria, IL (US)

(73) Assignee: Caterpillar Inc., Peoria, IL (US)

(21) Appl. No.: 14/667,013

(22) Filed: Mar. 24, 2015

(51) Int. Cl. B62D 55/21; F16C 17/12; F16C 33/20

(52) U.S. Cl. CPC B62D 55/21; F16C 33/203; F16C 17/12; F16C 33/208

(57) ABSTRACT

During the break-in period of track assembly components, galling can occur between the components during use. The components include a pin that is received within a bushing and alternatively a sleeve bearing between the pin and the bushing depending on the load. A method to prevent or reduce galling includes applying a coating of zinc phosphate and a low-friction layer on top of the zinc phosphate. The low-friction coating can be made of WS₂ (Tungsten Disulphide), BN (Boron Nitride), MoS₂ (Molybdenum disulfide) or PTFE (Polytetrafluoroethylene) and deposited during a mechanical treatment.

### TECHNICAL FIELD

The disclosure relates to a coating, and more specifically, a break-in coating for components of a machine.

### BACKGROUND

Machines often require two components that are linked together through some type of pin and a bushing. Examples include a wide variety of machines that utilize tracks as ground-engaging propulsion elements. It is common for such tracks to include a plurality of rotatable track engaging elements, with the track forming an endless loop moved about the rotating elements during operation. Such tracks typically include two chains of coupled together links, with bolted-on track shoes. The demands placed upon such machines and their associated track assemblies can be quite substantial, and the operating environments harsh. Machine tracks are often robust to provide a long operating life of thousands of hours despite significant mechanical stresses, strain and wear experienced during operation.

The wear phenomena experienced by machine track is typically a result of how the machine is used, the experience of the operator, and both the underfoot conditions and substrate materials in the operating environment. One such wear phenomenon relates to galling that can occur between the bushing and the pin. That is, wear is caused by adhesion between sliding surfaces of the bushing and pin. Field service life of machine track can vary based upon these factors from a few thousand hours to many thousands of hours. Since machine track components can be relatively costly, and servicing adds expense and machine down-time, engineers have long sought strategies for reducing and managing wear between and among the components.

U.S. Pat. No. 8,545,930 discloses a manufacturing method of mechanical elements that includes providing of a mechanical element having a rough curved surface preferably with a surface roughness of more than Sa=0.1 μm. The method is characterized by tribochemically depositing solid lubricant substance directly onto the rough curved surface in transverse directions. A mechanical element has a curved surface that includes a surface layer of a tribochemically deposited solid lubricant substance. A tool for manufacturing of such a mechanical element comprises a support portion, at least one tool working surface, means for providing a force pressing the tool towards the curved surface and driving means for moving said at least one tool working surface in two different directions along said curved surface. The working surface comprises an oxide, carbide and/or sulfide of an element capable of forming a stable sulfide. However, this method does not provide a lubricant surface that is prevents galling better than traditional steel bushing against a steel pin.

Thus, there is a need for an improved process that provides a break-in coating that more effectively reduces galling between the bushing and the pin.

### SUMMARY

In one aspect, a pin for use in a ground engaging machine is disclosed and includes a base material of hardened steel, a zinc phosphate coating applied on a top layer of the base material, and a low-friction layer applied on a top layer of the zinc phosphate coating, wherein the pin can be configured to be received within a bushing of the ground engaging machine.

In another aspect, a bushing for use in a ground engaging machine and includes a base material of hardened steel, and a low-friction layer applied to the base material, wherein the bushing is configured to receive a pin of the ground engaging machine.

In still another aspect a method of reducing galling of components in a ground engaging machine that includes applying a zinc phosphate coating to a hardened steel component of the ground engaging machine, applying a low-friction layer on a top layer of the zinc phosphate coating, and reducing galling of the component with the combination of the zinc phosphate and the low-friction layer.

In yet another aspect, an assembly that links components of a ground engaging machine is provided and includes a first component of the ground engaging machine, a second component of the ground engaging machine, wherein the assembling includes a bushing having a first base material of hardened steel, and a low-friction layer applied to the base material, wherein the bushing is configured to be received a pin of the ground engaging machine, and a pin having a second base material of hardened steel, a zinc phosphate coating applied on a top layer of the base material, and a low-friction layer applied on a top layer of the zinc phosphate coating, wherein the pin is configured to be received within the bushing of ground engaging machine, and wherein the bushing and the pin link the first and second components together.

### BRIEF DESCRIPTION OF THE DRAWINGS

FIG. 1 illustrates a machine having a ground-engaging track system according to an aspect of the disclosure.

FIG. 2 illustrates a partially sectioned diagrammatic view of a first track chain and a second track chain according to an aspect of the disclosure.

FIG. 3 illustrates the pin having a zinc phosphate coating and a low-friction layer according to an aspect of the disclosure.

FIG. 4 illustrates a chart of a single joint load test result for a pin and bushing having various coatings according to aspects of the disclosure.

### DETAILED DESCRIPTION

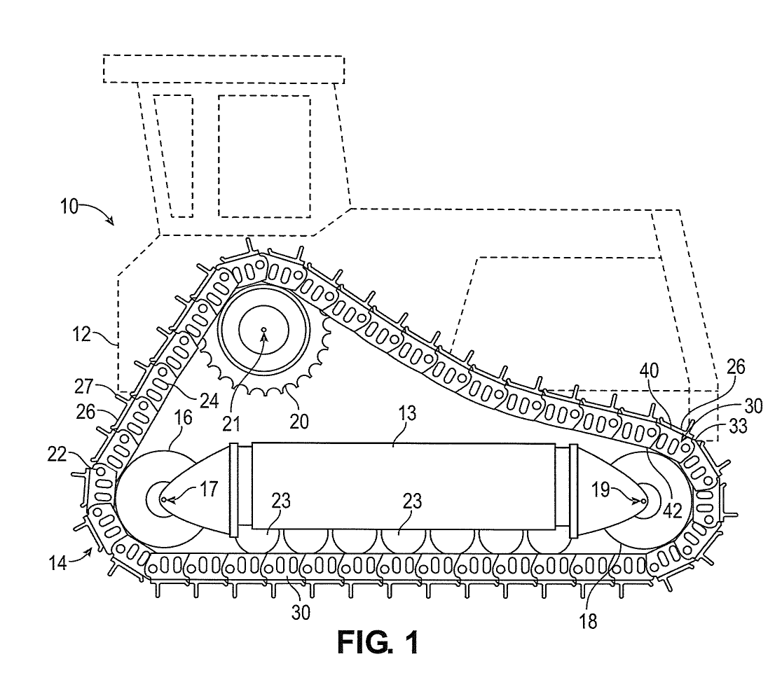

As previously noted, various machines require a pin and a bushing in order to link two components together. The components can include tracks on a ground-engaging machine or connecting a grabber coupler to a boom or any components that are desired to be linked together by a pin and bushing. Typically, the bushing receives the pin, which can rotate within the bushing and cause galling. FIG. 1 illustrates a machine 10 having a ground-engaging track system 14 according to an aspect of the disclosure. Machine 10 is shown in the context of a track-type tractor, but could be any of a variety of other machines such as a tracked loader, a half-track machine, or still others. Track system 14 may be one of two separate track systems positioned at opposite sides of a frame 12 of machine 10 in a conventional manner. Track system 14 may further include a track roller frame 13 coupled with machine frame 12, and a plurality of rotatable track-engaging elements 16, 18, and 20. In one embodiment, rotatable track engaging elements 16 and 18 include rotatable idlers configured to rotate passively during operation of track system 14, whereas element 20 includes a sprocket configured to drive track system 14. Track system 14 may further include a plurality of track rollers 23 configured to bear all or substantially all of a weight of machine 10, and is also mounted to track roller frame 13.

Track system 14 further includes a track 22 extending about each of rotatable track-engaging elements 16, 18 and 20 and track rollers 23. Elements 16, 18 and 20 each define an axis of rotation 17, 19 and 21, respectively, which axes may be parallel and arranged in a triangular pattern as shown. Track 22 may thus define a travel path about elements 16, 18 and 20 having a generally triangular shape. The embodiment shown in FIG. 1 will be understood by those skilled in the art as a “high-drive” track system, however, it should be appreciated that the present disclosure is not thereby limited.

Track 22 may include a first track chain 24, a second track chain which is hidden from view by track chain 24 in FIG. 1, and a plurality of track shoes 26 coupled with first track chain 24 and the second, hidden track chain. Each of track shoes 26 may include one or more grousers 27 in a conventional manner. Each of the first and second track chains may also include a plurality of elongate links 30, each including a link body 33. Each link body 33 may include a flat lower surface 40 in contact with one of track shoes 26, and an upper rail surface 42 presently in contact with one of elements 16 and 18, or configured to contact one of those elements via advancing of track 22 during operation, as the case may be. Those skilled in the art will appreciate that the upper rail surfaces 42 of each of links 30 together form rails in the two track chains upon which elements 16 and 18 and track rollers 23 ride. element 20, in contrast, may contact track 22 between links 30 rather than upon the rails.

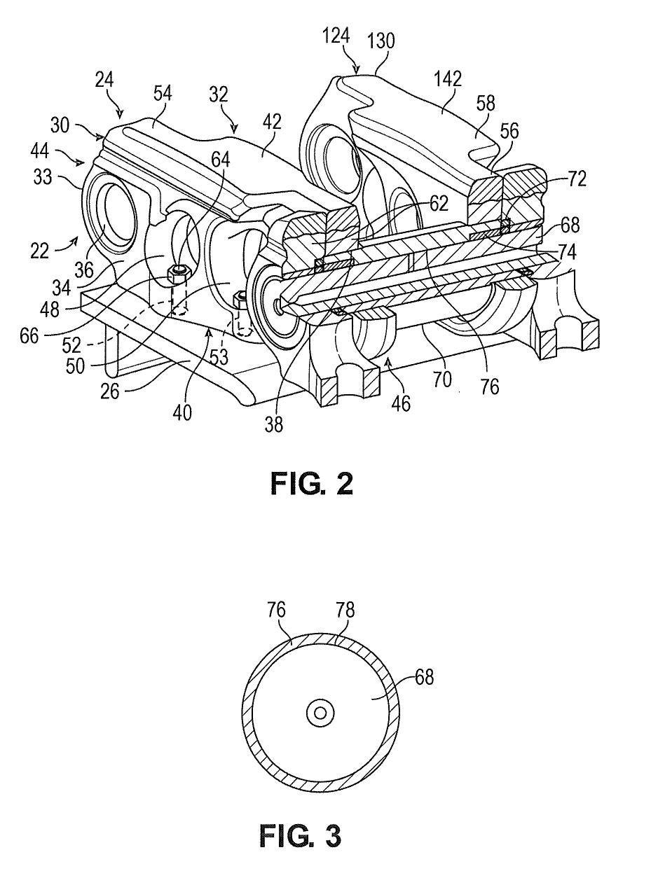

FIG. 2 illustrates a partially sectioned diagrammatic view of a first track chain 24 and a second track chain 124 according to an aspect of the disclosure. The first track chain 24 (a first component) may be coupled with the second track chain 124 (second component) via a plurality of track pins 68. A plurality of bushings 70, which may be rotatable or fixed, having a plurality bearings, such as thrust bearings or sleeve bearings 74 and a plurality of track pins 68 therein. Bushings 70 and track pins 68 may be made from any material including hardened steel (carbon steel, alloy steel, stainless steel and the like). The sleeve bearings 74 may be made from bronze, hardened steel (carbon steel, alloy steel, stainless steel and the like) or any other material. As the machine's horsepower increases, so does the likelihood of galling. For heavy load applications, nitrided steel sleeve bearings against a zinc phosphate coated steel pins may be used.

Track 22 may further be equipped with a plurality of track seals 72 associated with each set of bushings 70 and track pins 68, and a plurality of sleeve bearings 74. It may be noted from FIG. 2 that link 30, and a counterpart link 130 in track chain 124, are mirror images of one another. Accordingly, the present description should be understood to refer to any of the links in either of track chains 24 or 124, with consideration to the minor image relationship. Each of the links within each track chain may be identical, but for a master link in certain embodiments.

Link body 33 may include an inboard side 32 and an outboard side 34. Link body 33 further defines a first track pin bore 36 formed in a first link body end 44, and a second track pin bore 38 formed in a second link body end 46. Each of track pin bores 36 and 38 communicate between inboard side 32 and outboard side 34. In a practical implementation strategy, first track pin bore 36 may have an interference fit with one of the track pins 68, whereas second track pin bore 38 may have an interference fit with one of the bushings 70. Each link 30 and 130 may further include a medium hardened material 62, and first and second track pin bores 36 and 38 may be defined by medium hardened material 62 so as to avoid difficulties in forming the interference fits mentioned above. The present disclosure is nevertheless not limited to any particular materials, material hardness, or for that matter track assembly strategy. For instance, rather than utilizing interference fits in whole or in part, pin retention strategies of another sort might be used to couple ends of the track pins to track links. As noted above, the bushings might freely rotate about the track pins.

It is contemplated that a variety of track link designs fall within the context of the present disclosure. In one practical implementation strategy, links 30 and 130 may be S-shaped, although in other embodiments they might be straight. Those skilled in the art will be familiar with the difference between S-shaped and straight links. In S-shaped links as shown, bores 36 and 38 are laterally offset from one another, in other words not aligned in an inboard to outboard direction. Upper rail surfaces 42, 142 also have a geometry generally S-shaped, when viewed from above, and such that a center section 58 of upper rail surfaces 42, 142 extends between a first end section 54 and a second end section 56 laterally offset from first end section 54. Link 30 further defines a first window 48 and a second window 50 communicating between the inboard side 32 and the outboard side 34. A first bolting bore 52 and a second bolting bore 53 extend inwardly from lower surface 40 and intersect first and second windows 48 and 50, respectively. Track system 14 further comprises bolts 64 which are received within bolting bores 52 and 53 in link 30, and attach one of track shoes 26 to the corresponding link 30. Nuts 66 may be positioned within windows 48 and 50 and engaged with bolts 64.

As the bushing 70 and track pin 68 interact with each other, a lubricant such as synthetic gear oil can be used to reduce the friction between the two components. In addition to or without the use of lubricant, in an aspect of the disclosure, the bushing 70 can be mainly made from hardened steel. In another aspect of the disclosure the bushing 70 can have an inner diameter treated with zinc phosphate coating. The zinc phosphate has a top layer and produces more complex layers of crystals, which absorbs lubricants more readily. This makes zinc phosphate more effective in reducing galling, pick up and scuffing. Phosphate coatings can range from less than 0.1 mm to over 2 mm in thickness and can be applied using various processes such as spraying, immersion, electroplating, or a combination thereof. The zinc phosphate can also provide corrosion resistant of metal parts. Additionally, a low-friction layer 76 may also be applied to decrease galling that could occur when the bushing 70 contacts components such as the pin 68, sleeve bearing 74 or other components. The low-friction layer 76 may be applied on to the bushing 70 on a top layer of the zinc phosphate coating or a top layer of hardned steel of the bushing. The low-friction layer 76 may also be wear resistant. The low-friction layer 76 may be formed using a thermoset surface coating, such as Tricolit® which may include one or more of WS₂ (Tungsten Disulphide), BN (Boron Nitride), PTFE (Polytetrafluoroethylene), MoS₂ (Molybdenum disulfide) and graphite embedded in a matrix. The thermoset coating may be applied via dipping, spraying, brushing and the like and functions whether in dry or lubricated contacts. This process may start by cleaning the bushing using solvents, water, cleaners and the like until unwanted contaminants are removed and the surface is prepped to receive the coating. Then the thermoset coating can be applied via dipping, spraying or brushing followed by a heat treatment to cure or set the thermoset coating.

In another aspect of the disclosure, the low-friction layer 76 may be applied such that the bushing 70 can be subjected to a mechanical surface treatment that includes milling, sanding, machining, appropriate pressure for mechanical burnishing, and the like along with a deposition of a film such as a low-friction, wear resistant film of WS₂ (Tungsten Disulphide), BN (Boron Nitride), PTFE (Polytetrafluoroethylene), MoS₂ (Molybdenum disulfide) or other friction modifiers. The appropriate pressure may range from 80-250 MPa and can be more or less depending on the film and other conditions. This process results in a bushing 70 with a smoother surface having a significantly reduced coefficient of friction resulting in increased load carrying capacity and wear resistance. Further, the mechanical surface treatment, such as tribocoditioning, allows for a modified surface roughness profile or a more uniform surface with less peaks and valleys than non-mechanically treated surfaces.

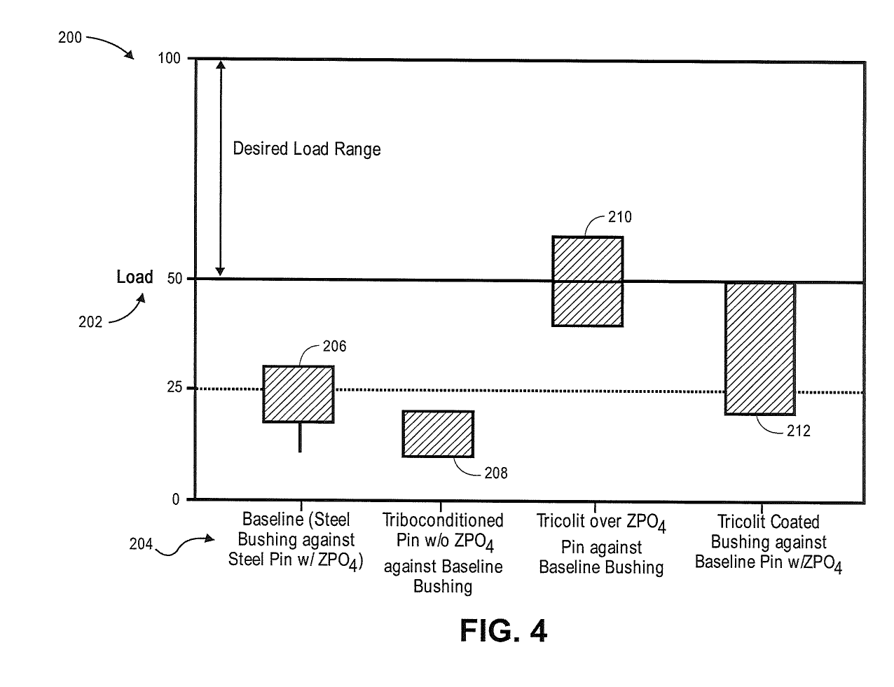

As discussed in FIG. 4, by having the low-friction layer 76 applied, the bushing 70 will have an increases load range as compared to being without the low-friction layer 76. It should be noted that the sleeve bearing 74 or any other type of bearings may be subjected to the same or similar processes as the bushing 70 as discussed herein in order to have the same effect of an increased load range.

FIG. 3 illustrates the pin 68 having a zinc phosphate coating 78 and a low-friction layer 76 according to an aspect of the disclosure. The pin 68 can be received in the bushing 70 or within a sleeve bearing 74 or both. The pin 68 can be made from hardened steel that can gall when interacting with the bushing 70 or the sleeve bearing 74. In one aspect of the disclosure, the pin 68 can include a first coating of zinc phosphate 78 that is applied over a top layer of the hardened steel. In another aspect, a second coating or the low-friction layer 76 can be applied on top layer of the zinc phosphate 78. As noted above, the zinc phosphate 78 produces more complex layers of crystals, which absorbs lubricants more readily. This makes zinc phosphate more effective in reducing galling, pick up and scuffing. Phosphate coatings can range from less than 0.1 mm to over 2 mm in thickness and can be applied using various processes such as spraying, immersion, electroplating, or a combination thereof.

The low-friction layer 76 may be formed using a thermoset surface coating, such as Tricolit® which may include one or more of WS₂ (Tungsten Disulphide), BN (Boron Nitride), PTFE (Polytetrafluoroethylene), MoS₂ (Molybdenum disulfide) and graphite embedded in a matrix. The thermoset coating may be applied via dipping, spraying, brushing and the like and functions whether in dry or lubricated contacts. This process may start by cleaning the bushing using solvents, water, cleaners and the like until unwanted contaminants are removed and the surface is prepped to receive the coating. Then the thermoset coating can be applied via dipping, spraying or brushing followed by a heat treatment to cure or set the thermoset coating.

In another aspect of the disclosure, the low-friction layer 76 may be applied such that the pin 68 can be subjected to a mechanical surface treatment that includes milling, sanding, machining, extreme pressure mechanical burnishing, and the like along with a deposition of a film such as a low-friction, wear resistant film of WS₂ (Tungsten Disulphide), BN (Boron Nitride), PTFE (Polytetrafluoroethylene), MoS₂ (Molybdenum disulfide) or other friction modifiers. This process results in the pin 68 with a smoother surface having a significantly reduced coefficient of friction resulting in increased load carrying capacity and wear resistance. Further, the mechanical surface treatment, such as tribocoditioning, allows for a modified surface roughness profile or a more uniform surface with less peaks and valleys than non-mechanically treated surfaces. As will be shown below in FIG. 4, a pin 68 having the two coatings will fail at a higher load than a standard pin.

FIG. 4 illustrates a chart 200 of a single-joint load test result for a pin 68 and bushing 70 having various coatings according to aspects of the disclosure. The x-axis 204 shows the coating, if any, on the bushing 70 and the pin 68 while the y-axis 202 is the load fail or when the single joint will fail in load units. As illustrated in FIG. 4, a data point 206 is for a steel bushing 70 against a steel pin 68 that is coated with the zinc phosphate and can withstand a load of 30 units. Meanwhile, a data point 208 is for a triboconditioned pin without zinc phosphate against steel bushing and can withstand about 20 units of load, which is less than data point 206. Data point 210 is for a tricolit over a zinc phosphate coated steel pin 68 against steel bushing and can withstand about 60 units of load, which is higher than data points 206, 208, and 212. Data point 212 is for a tricolit layer coated bushing 70 against a zinc phosphate coated steel pin 68 and can withstand about 50 units of load, which is higher than data points, 206 and 208. Thus, as shown by data points 210, 212, having low-friction layer 76 over a zinc phosphate coating 78, applied as discussed above (for the coating 78 and layer 76) provides the best protection against galling and allows the pin 68 and bushing 70 to operating in the desired load range. The preferred load fail range is between 50-100 units of load. Also, as shown at data point 208, having the low-friction layer 76 alone (without the zinc phosphate) is not as good as having both the low-friction layer 76 and the coating 78, as shown in data point 210.

### INDUSTRIAL APPLICABILITY

Improved coatings for machine components, such as a track assembly, are provided. Components of the track assembly include a bushing having a pin therein in order to connect two tracks together. Alternatively, a sleeve bearing can be introduced between the bushing and the pin. The interactions of the bushing and pin can cause galling during the break in period. Lubricants are used to reduce the friction between the bushing and pin but galling can still occur. The improved process includes coating the components with a coat of zinc phosphate with or without a low-friction layer.

The low-friction layer 76 may be formed using a thermoset surface coating, such as Tricolit® which may include one or more of WS₂, BN (Boron Nitride), PTFE (Polytetrafluoroethylene), MoS₂ (Molybdenum disulfide) and graphite embedded in a matrix. The thermoset coating may be applied via dipping, spraying, brushing and the like and functions whether in dry or lubricated contacts. The low-friction layer 76 may be applied such that the bushing or pin can be subjected to a mechanical surface treatment that includes milling, sanding, machining, appropriate pressure mechanical burnishing, and the like along with a deposition of a film such as a low-friction, wear resistant film of WS₂ (Tungsten Disulphide), BN (Boron Nitride), PTFE (Polytetrafluoroethylene), MoS₂ (Molybdenum disulfide) or other friction modifiers. This process results in the bushing or pin with a smoother surface having a significantly reduced coefficient of friction resulting in increased load carrying capacity and wear resistance. The low-friction layer in addition to the zinc phosphate coating provides minimal to low galling from the interactions of the bushing and the pin than having a zinc coating or the low-friction layer by itself.

We claim:

1. A pin for use in a ground engaging machine, the pin comprising:
a base material of hardened steel;
a zinc phosphate coating applied on a top layer of the base material; and
a low-friction layer applied on a top layer of the zinc phosphate coating, wherein the pin is configured to be received within a bushing of the ground engaging machine.

2. The pin of claim 1, wherein the low-friction layer is a thermoset surface coating.

3. The pin of claim 2, wherein the thermoset surface coating is one of the following: WS₂ (Tungsten Disulphide), BN (Boron Nitride), MoS₂ (Molybdenum disulfide) or PTFE (Polytetrafluoroethylene).

4. The pin of claim 2, wherein the thermoset surface coating is one of the following: WS₂ (Tungsten Disulphide), BN (Boron Nitride), MoS₂ (Molybdenum disulfide) or PTFE (Polytetrafluoroethylene) with a graphite embedded in a matrix.

5. The pin of claim 1, wherein the low-friction layer is applied using an appropriate pressure mechanical burnishing while depositing WS₂ (Tungsten Disulphide), BN (Boron Nitride), MoS₂ (Molybdenum disulfide) or PTFE (Polytetrafluoroethylene).

6. The pin of claim 2, wherein the thermoset surface coating is applied via dipping, spraying or brushing followed by a heat treatment.

7. The pin of claim 1, the low-friction layer is applied using a mechanical surface treatment while depositing WS₂ (Tungsten Disulphide), BN (Boron Nitride), MoS₂ (Molybdenum disulfide) or PTFE (Polytetrafluoroethylene).

8. A bushing for use in a ground engaging machine, the bushing comprising:
a base material of hardened steel; and
a low-friction layer applied to the base material, wherein the bushing is configured to receive a pin of the ground engaging machine.

9. The bushing of claim 8 further comprising a zinc phosphate coating applied on a top layer of the base material, the zinc phosphate coating includes a top layer that receives the low-friction layer, wherein the low-friction layer is a thermoset surface coating.

10. The bushing of claim 9, wherein the thermoset surface coating is one of the following:
WS₂ (Tungsten Disulphide), BN (Boron Nitride), MoS₂ (Molybdenum disulfide) or PTFE (Polytetrafluoroethylene).

11. The bushing of claim 9, wherein the thermoset surface coating is one of the following:
WS₂ (Tungsten Disulphide), BN (Boron Nitride), MoS₂ (Molybdenum disulfide) or PTFE (Polytetrafluoroethylene), with a graphite embedded in a matrix.

12. The bushing of claim 8, wherein the low-friction layer is applied using an appropriate pressure mechanical burnishing while depositing WS₂ (Tungsten Disulphide), BN (Boron Nitride), MoS₂ (Molybdenum disulfide) or PTFE (Polytetrafluoroethylene).

13. The bushing of claim 9, wherein the thermoset surface coating is applied via dipping, spraying or brushing followed by a heat treatment.

14. The bushing of claim 8, the low-friction layer is applied using a mechanical surface treatment while depositing WS₂ (Tungsten Disulphide), BN (Boron Nitride), MoS₂ (Molybdenum disulfide) or PTFE (Polytetrafluoroethylene).

15. A method of reducing galling of components in a ground engaging machine, comprising the steps of:
applying a zinc phosphate coating to a hardened steel component of the ground engaging machine;
applying a low-friction layer on a top layer of the zinc phosphate coating; and
reducing galling of the component with the combination of the zinc phosphate coating and the low-friction layer.

16. The method of claim 15, wherein applying the low-friction layer through using an appropriate pressure mechanical burnishing while depositing WS₂ (Tungsten Disulphide), BN (Boron Nitride), MoS₂ (Molybdenum disulfide) or PTFE (Polytetrafluoroethylene).

17. The method of claim 15, wherein the low-friction layer is a thermoset surface coating applied via dipping, spraying or brushing.

18. The method of claim 15, wherein the low-friction layer is applied using a mechanical surface treatment while depositing WS₂ (Tungsten Disulphide), BN (Boron Nitride), MoS₂ (Molybdenum disulfide) or PTFE (Polytetrafluoroethylene).

19. The method of claim 15, wherein the component is part of track assembly that includes a pin, a bushing or a sleeve.

20. The method of claim 15 further comprising the step of applying a heat treatment to the component.

21. An assembly that links components of a ground engaging machine, comprising:
a first component of the ground engaging machine;
a second component of the ground engaging machine, wherein the assembly comprises:
a bushing comprising:
a first base material of hardened steel; and
a low-friction layer applied to the base material, wherein the bushing is configured to receive a pin of the ground engaging machine; and
a pin comprising:
a second base material of hardened steel;
a zinc phosphate coating applied on a top layer of the base material; and
a low-friction layer applied on a top layer of the zinc phosphate coating, wherein the pin is configured to be received within the bushing of ground engaging machine, and wherein the bushing and the pin link the first and second components together.

22. The assembly of claim 21, wherein the low-friction layer is a thermoset surface coating.

23. The assembly of claim 22, wherein the thermoset surface coating is one of the following: WS₂ (Tungsten Disulphide), BN (Boron Nitride), MoS₂ (Molybdenum disulfide) or PTFE (Polytetrafluoroethylene).

24. The assembly of claim 21, wherein the low-friction layer is applied using an appropriate pressure mechanical burnishing while depositing WS₂ (Tungsten Disulphide), BN (Boron Nitride), MoS₂ (Molybdenum disulfide) or PTFE (Polytetrafluoroethylene).

25. The assembly of claim 22, wherein the thermoset surface coating is applied via dipping, spraying or brushing followed by a heat treatment.

26. The assembly of claim 21, wherein the first component is a first track chain and the second component is a second track chain.
